(19) United States
(12) Patent Application Publication
(10) Pub. No.: US 2012/0150711 A1
(43) Pub. Date: Jun. 14, 2012

(54) LINKED SHORT ORDER AND SECURITIES LOAN OR LOCATE

(75) Inventors: Gregory Wayne DePetris, Guilford, CT (US); Martin Rein Hakker, Northport, NY (US); Thomas Walter Little, JR., New York, NY (US); Sergei Poliakoff, New York, NY (US)

(73) Assignee: Automated Equity Finance Markets, Inc., New York, NY (US)

(21) Appl. No.: 12/963,840

(22) Filed: Dec. 9, 2010

(51) Int. Cl. G06Q 40/00

(52) U.S. Cl. 705/37

(57) ABSTRACT

A stock loan system receives a sell short order for a financial instrument such as a stock, and determines whether it can provide a locate for the sell short order. If so, then the stock loan system sends sell short order and the locate to a marketplace for execution. In some cases, the sell short order is required to have a stock loan, not merely a locate, to be eligible for execution, and the stock loan system provides the loan, then sends the sell short order with notice of the loan to a marketplace for execution. In some embodiments, an order execution marketplace receives a sell short order for a financial instrument, and, if it can provide a locate, the marketplace provides the locate and executes the sell short order. In some cases, the sell short order is required to have a stock loan, not merely a locate, to be eligible for execution, and the marketplace obtains a stock loan from a stock loan system then executes the sell short order.

### BACKGROUND OF THE INVENTION

The present invention relates to a financial market system, and more particularly, is directed to provision of a locate for a stock loan.

Traders who expect the price of a stock to go down would like to sell the stock short, meaning sell the stock now and, at some future time, buy the stock that they previously sold. Regulations require that such traders obtain a loan of the stock to deliver to the buyer. Thus, there are people who want to borrow stock.

Other parties, such as pension funds, purchase stock for the long-term. These parties are willing to loan their stock in return for a fee, to increase their rate of return. Thus, there are people who want to lend stock.

The present applicants have previously proposed a system for trading stock loans.

SEC Regulation SHO requires short sellers in all equity securities to locate securities to borrow before selling, see http://www.sec.gov/rules/final/34-50103.htm. In the securities marketplace, a trade that occurs on “day T” is supposed to settle, that is, cash and stock are transferred between seller and borrower, three business days later on “day T+3”. So, the actual stock loan occurs on day T+3.

To bridge the time difference between day T and day T+3, so-called “locate” practice is used in the securities industry. A locate is an affirmative determination that a party will provide the named quantity of securities three days hence. However, a locate is not an enforceable contract.

A trader can obtain a locate by asking a broker, such as by telephone, email or instant message, or by consulting a locate file provided by the broker to the trader each morning, listing the inventory that the broker has available to loan.

Not all locates are actually converted into loans. Reasons for non-conversion include that the stock is either not needed as the short seller closed her position prior to T+3 or that the stock was actually loaned by a party other than the locate provider.

It is desirable for the proposed system for trading stock loans to also be able to provide locates.

### SUMMARY OF THE INVENTION

In accordance with an aspect of this invention, there is provided a method of providing a locate for a stock loan for a hard to borrow stock, comprising: receiving a request for the locate, the request being for a requested quantity, from an entity holding a sell short order for a hard to borrow stock, and automatically determining, by a program executing on a computer, an available quantity in a file, whether there is sufficient available quantity to provide the requested quantity. When there is sufficient available quantity, automatically decrementing, by the program, the available quantity by the requested quantity, and replying to the entity with a locate for the requested quantity.

In accordance with another aspect of this invention, there is provided a method of providing a locate for a stock loan for a hard to borrow stock, comprising in a process executing on a computer, creating a hard to borrow file, sending the hard to borrow file to a marketplace, and receiving a locate usage report from the marketplace.

In accordance with a further aspect of this invention, there is provided a method of providing a stock loan for a sell short order, comprising receiving, at a computer, the sell short order from a trader, automatically, at the computer, obtaining a stock loan corresponding to the sell short order, and sending the sell short order and notice of the stock loan from the computer to a first marketplace for execution of the sell short order.

In accordance with a still further aspect of this invention, there is provided a method of providing a stock loan for a sell short order, comprising receiving, at a computer, a request for the stock loan from a marketplace, automatically, at the computer, obtaining a stock loan corresponding to the sell short order, and sending a notice to the marketplace that a stock loan was obtained.

In accordance with a yet further aspect of this invention, there is provided a method for executing a sell short order, comprising receiving, at a computer operated by a marketplace, the sell short order associated with a stock symbol, and determining, at the computer, whether the stock symbol is in a GC file maintained at the computer or a HTB file maintained at the computer. When the stock symbol is in the GC file or a HTB file, creating, at the computer, a locate for the sell short order, and executing, at the computer, the sell short order.

In accordance with yet another aspect of this invention, there is provided a method for executing a sell short order, comprising receiving, at a computer operated by a marketplace, the sell short order associated with a stock symbol, and determining, at the computer, whether the stock symbol is in a pre-borrow file maintained at the computer. When the stock symbol is in the pre-borrow file, sending a request for a stock loan to a stock lending system, and receiving, at the computer, a notice from the stock lending system that the loan was granted, and then executing, at the computer, the sell short order.

It is not intended that the invention be summarized here in its entirety. Rather, further features, aspects and advantages of the invention are set forth in or are apparent from the following description and drawings.

### BRIEF DESCRIPTION OF THE DRAWINGS

FIG. 1 is a block diagram showing a conventional configuration for short selling;

FIG. 2A is a flowchart showing conventional activity for a short sale on day T;

FIG. 2B is a flowchart showing conventional activity for a short sale on day T+3;

FIG. 3 is a block diagram showing a stock loan trading system;

FIG. 4A is a chart showing a portion of a data record for a stock symbol;

FIG. 4B is a chart showing a portion of a stock trade order;

FIG. 4C is a chart showing a GC Locate File;

FIG. 4D is a chart showing a HTB Locate File;

FIG. 4E is a chart showing a Reg SHO Pre-Borrow File;

FIGS. 5A-5I are block diagrams representing various configurations for processing a sell short order in combination with a locate or in combination with a loan;

FIGS. 6A-6D are flowcharts showing four respective embodiments of providing a locate, in a stock loan system;

FIG. 7 is a flowchart showing activity for a short sale on day T using the stock loan system;

FIGS. 8A-8B are flowcharts showing two respective embodiments of providing a stock loan for a short sale order, in a stock loan system;

FIG. 9 is a flowchart showing post-trade activity for a short sale using the stock loan system; and

FIG. 10 is a flowchart showing processing for a stock loan request having associated orders to be triggered if the loan is obtained.

### DETAILED DESCRIPTION

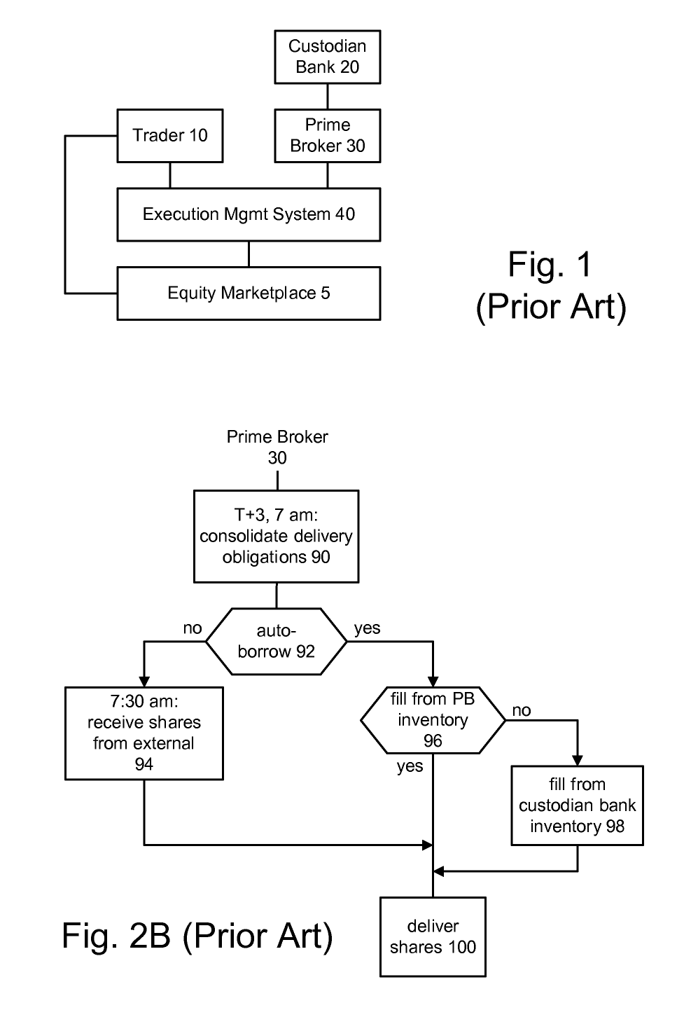

FIG. 1 is a block diagram showing a conventional configuration for short selling.

Custodian bank 20 has securities it wishes to lend. Custodian bank 20 notifies a prime broker 30 of the availability of shares to lend. Prime broker 30 communicates with execution management system (EMS) 40, typically providing a file at the start of each day indicating how many shares of which securities it has for locates.

Securities available for locate provision via EMS 40 are either general collateral (GC) securities or hard to borrow (HTB) securities. GC stock is widely available, that is, there is never a shortage of GC shares. HTB stock has more demand than availability. GC and HTB are terms applied in practice, depending on market activity.

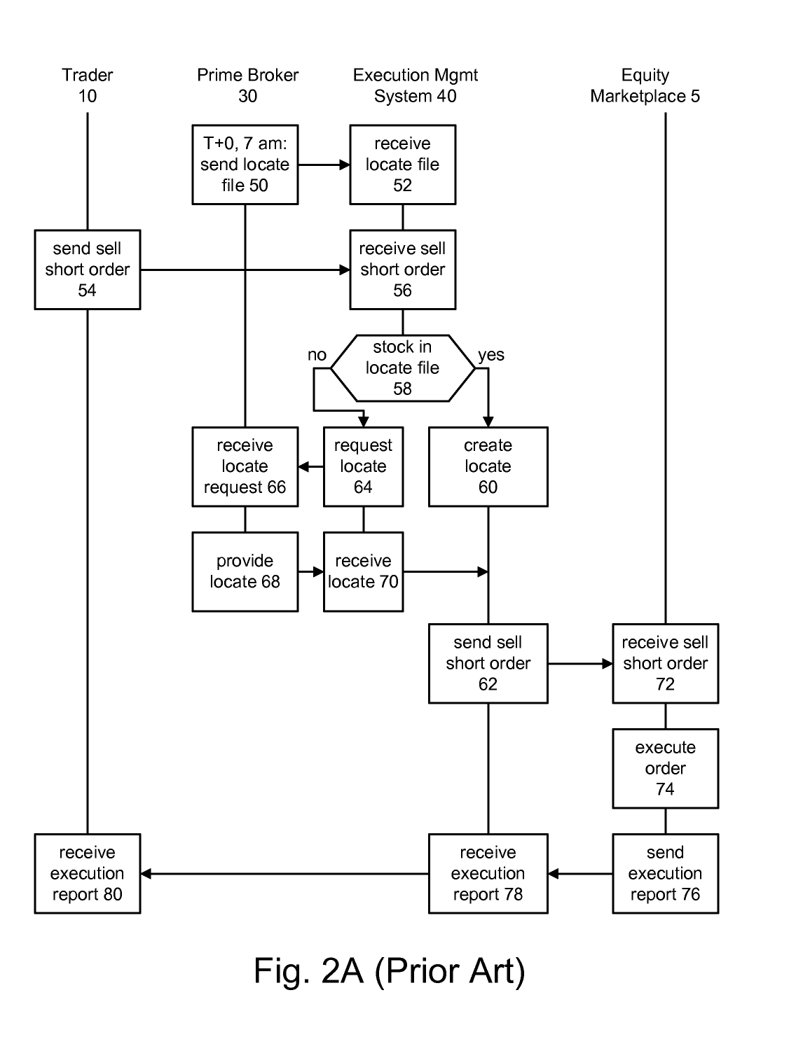

Trader 10, who wishes to short sell a security, communicates with EMS 40 and sends the short sale order thereto, as described in detail in FIG. 2. EMS 40 obtains a locate and sends the short sale order to equity marketplace 5.

Trader 10 is also able to send orders directly to equity marketplace 5, such as buy orders or regular sell orders.

In accordance with regulatory requirements, equity marketplace 5 accepts sell short orders for GC and HTB security symbols only when the sell short orders are associated with a locate.

FIG. 2A is a flowchart showing conventional activity for a short sale on day T.

At step 50, broker 30 sends its locate file to EMS 40. At step 52, EMS 40 receives the locate file.

At step 54, trader 10 sends a sell short order for a particular quantity of a particular stock to EMS 40. At step 56, EMS 40 receives the sell short order. At step 58, EMS 40 checks whether the locate file includes the stock in sufficient quantity. If so, then at step 60, EMS 40 creates a locate and appends a locate identifier to the sell short order ticket, usually an electronic message but could be a paper ticket. At step 62, EMS 40 sends the short sell order to equity marketplace 5. At step 72, equity marketplace 5 receives the short sell order, and at step 74, executes it, then at step 76, sends an execution report to EMS 40, which in turn sends a copy of the execution report to trader 10. At step 80, trader 10 receives the execution report.

If, at step 58, EMS 40 determines that the locate file does not allow provision of a locate for the sell short order, then at step 64, EMS 40 sends a locate request to broker 30. Alternatively, as step 64, trader 10 manually obtains a locate, such as by voice call to a locate provider. At step 66, broker 30 receives the locate request, and at step 66, broker 30 provides the locate. At step 70, EMS 40 receives the locate, and processing continues at step 62.

FIG. 2B is a flowchart showing conventional activity for a short sale on day T+3.

At step 90, broker 30 consolidates its delivery obligations. At step 92, broker 30 determines whether it needs to automatically borrow or whether the stock will be delivered to broker 30 from an external party. If from external, then at step 94, broker 30 must receive the shares by 7:30 am, typically via notice from a depository corporation that shares have been transferred to its account. If borrowing is needed, at step 96, broker 30 first checks to determine whether it has the needed stock in its own inventory, if so, it provides the stock. If not, then at step 98, broker 30 uses inventory from its custodian bank clients. At step 100, broker 30 delivers the shares to a depository corporation from its account to the account of the buyer on the other side of the short sale.

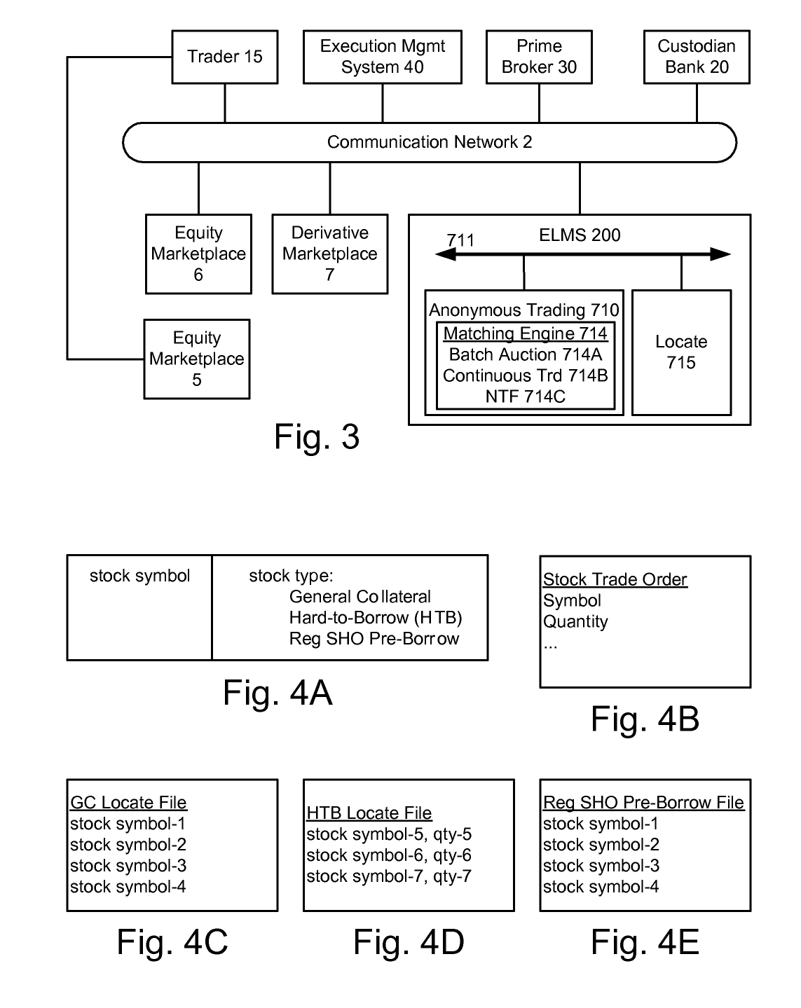

FIG. 3 is a block diagram showing a stock loan trading system, electronic loan market system (ELMS) 200, proposed by the present inventors, assigned to the assignee of the instant application, and described in detail in U.S. patent application Ser. No. 12/321,600, the disclosure of which is hereby incorporated by reference in its entirety.

Although it is assumed that a sell short order is for a stock, the present invention is not so limited and may be used for any fungible financial instrument.

Communication network 2 may be any combination of a public and/or private communication network, and may employ wireline or wireless transmission. Each of trader 15, EMS 40, prime broker 30, custodian bank 20, equity marketplace 6, derivative marketplace 7 and ELMS 200 communicate with communication network 2, and thence with each other as appropriate. Each of trader 15, EMS 40, prime broker 30, custodian bank 20, equity marketplace 6, and derivative marketplace 7 is embodied as a general purpose computer programmed to operate in accordance with the present invention, using appropriate software programs and communications capabilities.

Trader 15 is also able to send orders to equity marketplace 5, a conventional equity marketplace that is unaware of ELMS 200. ELMS 200 does not communicate directly with equity marketplace 5.

Derivative marketplace 7 accepts orders electronically for derivative instruments such as options and/or futures, generally derivative of securities, but possibly for other items such as commodities.

ELMS 200 is a computer system having one or more general purpose computers executing software for performing its functions, as discussed below, along with suitable communication facilities for its users, also referred to a market participants. ELMS 200 is provided with suitable equipment, such as memory, storage (e.g., magnetic, optical, magneto-optical or other suitable storage), input peripherals (e.g., keyboard, voice input, communication channel input) and output peripherals (e.g., displays, printers). ELMS 200 is provided with suitable software infrastructure, such as operating system, communication channel drivers, device drivers and so on. ELMS 200 includes internal communication network 711 coupled to one or more computer processors executing anonymous trading module 710 and locate module 715.

Anonymous trading module 710 may be implemented on a series of server computers sharing a common bus and database. In one embodiment, anonymous trading module 710 is a customized version of the Cinnober TRADExpress Platform, described at www.cinnober.com.

Price discovery occurs in matching engine 714 of anonymous trading module 710 of ELMS 200. The purpose of price discovery is to engage in a trade. Price discovery can occur in a batch auction, a continuous auction, or in a negotiated trade.

Trade execution, that is, formation of a stock loan, can occur via a batch auction in batch auction module 714A, via continuous trading in continuous trade module 714B, or via a negotiated trade in negotiated trade facility 714C.

Each of the batch auction and continuous auction is operative to provide a primary market and a secondary market, with eligibility for the primary market depending on good behavior, as described in the Ser. No. 12/321,600 patent application.

In batch auction module 714A, batch auctions are held, on a security-by-security basis, at predetermined daily times, such as 9 am, 10 am, noon, 2 pm and 4 pm, or at every half-hour. Lenders and borrowers submit inventory and needs for particular auctions to an order book. Batch auction module 714A sets a single price, referred to as the equilibrium price, for each auction so as to maximize the amount traded. However, there is no guarantee that any particular inventory or request will trade during a specific auction. An equilibrium price is a price having quantity available for trading on both sides, and for which the minimum quantity on a side is maximum relative to the minimum quantity at other prices having quantity available for trading on both sides. If several prices meet these conditions, then the price closest to the previous equilibrium price is used.

Continuous trading module 714B is inoperative during a batch auction, and is operative in the intervals between batch auctions at the last batch auction execution price. After a batch auction, some of the orders at the auction price may remain unexecuted (“residual orders”). These residual orders are available to a continuous trading process. Traders can then execute against these residual orders at the last auction price until the next auction occurs. Continuous trading module 714B ensures that the execution comports with credit limits set by ELMS 200. A trader can also enter a new order at the last auction price to an electronic order book (not shown) associated with anonymous trading module 710, in which case the new order is available for continuous trading.

In NTF module 714C, traders enter trading interests to find other traders to negotiate with via exchanging structured messages. The traders are anonymous but have system-generated ratings that are displayed to other traders. A trader can negotiate with multiple parties and then pick one to trade with.

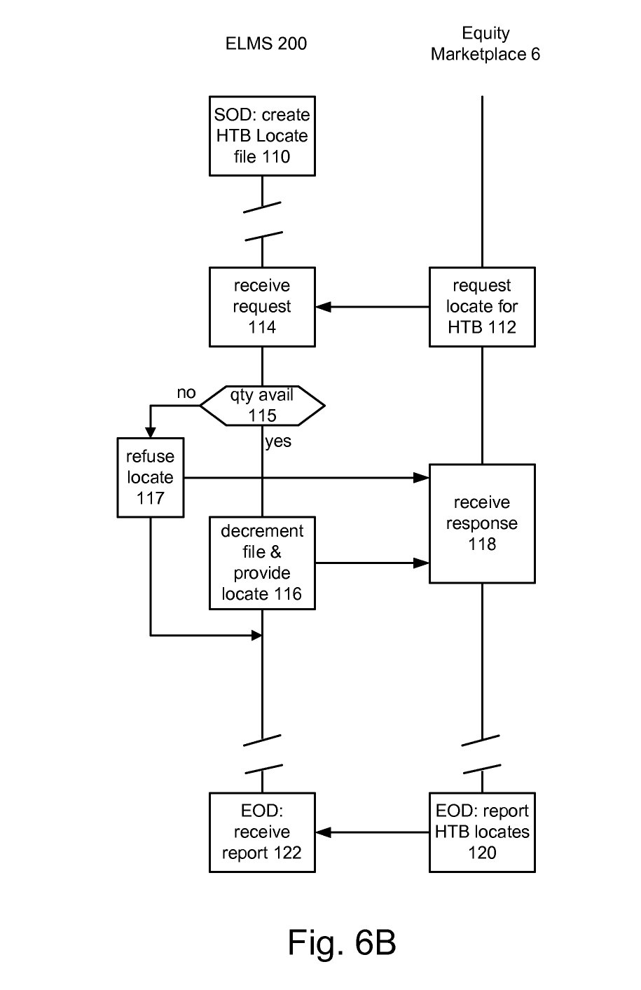

Locate module 715 is software that operates to perform the functions described in detail with regard to FIGS. 6A-6C, 7A-7B and 8A-8B.

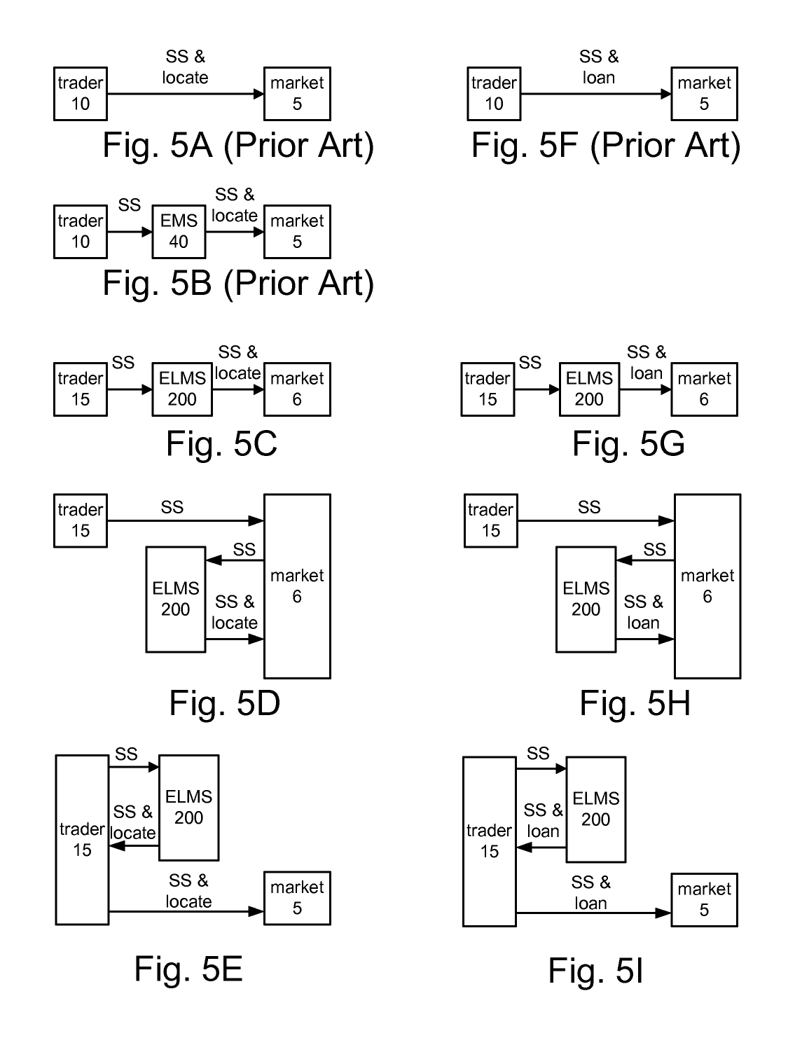

FIG. 4A is a chart showing a portion of a data record for a stock symbol. Each stock symbol has an associated stock type having one of three values: general collateral (GC), hard to borrow (HTB) or Reg SHO Pre-borrow. General collateral stock is widely available, that is, there is always more supply of GC stock than there is demand to borrow it. HTB stock typically has more demand than supply. Pre-borrow stock, by virtue of SEC Regulation SHO, must be borrowed prior to short selling it, that is, locates cannot be used for Pre-borrow stock.

FIG. 4B is a chart showing a portion of a stock trade order. Certain firms cannot use locates for their short sale orders and must pre-borrow the stock, generally due to regulatory action. These firms are colloquially referred to as “in the penalty box”.

FIG. 4C is a chart showing a daily GC Locate File, and is seen to be simply a listing of stock symbols for the GC stock. Quantity is not required, because there is always more quantity of GC stock available for borrow than there is demand to borrow it. Generally, ELMS locate module 715 updates the GC Locate file, if at all, in a start-of-day process.

FIG. 4D is a chart showing a daily HTB Locate File, and is seen to be a listing of stock symbols and associated quantity available for borrowing. As locates are provided for HTB stock, the quantity field is decremented. ELMS locate module 715 creates the HTB locate file in a start-of-day process.

The HTB locate file is created according to a “historical calculated” method, an “actual” method or an “estimated” method. In the historical calculated method, the quantity for each symbol is estimated based on a moving window of several days' previous borrowing activity on ELMS 200, such as three preceding days, or three days from a previous month. In the actual method, the quantity for each symbol corresponds to actual amounts available as provided by members of ELMS 200, and may be updated during the day as members make more HTB stock available. In the estimated method, the quantity for each symbol is determined by summing availability estimates provided by members of ELMS 200.

In embodiments wherein different methods may be used for determining available quantity of different HTB symbols, there is a field indicating how the HTB quantity was determined for each symbol.

FIG. 4E is a chart showing a daily Regulation SHO Pre-borrow File, and is seen to be a listing of stock symbols that must be pre-borrowed before short selling. Generally, ELMS locate module 715 receives this file, or updates to it, in a start-of-day process responsive to regulatory action.

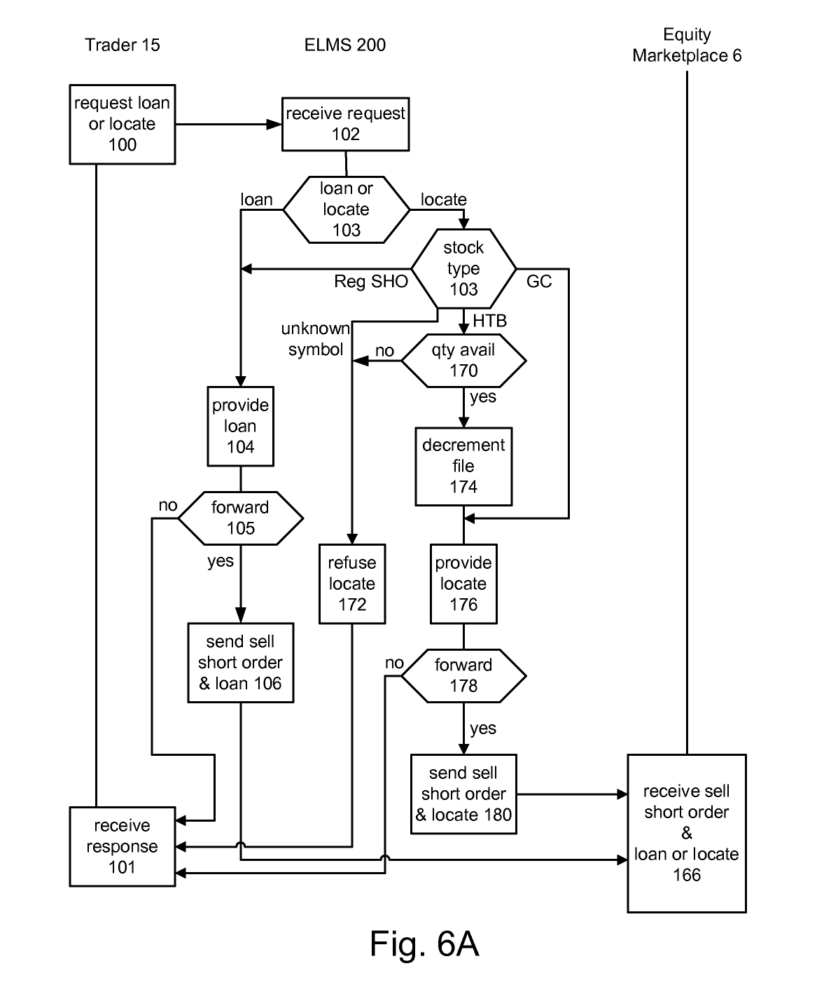

FIGS. 5A-5I are block diagrams representing various configurations for processing a sell short order in combination with a locate or in combination with a loan. These are high level representations.

FIGS. 5A-5E relate to locates for GC and HTB stock. FIGS. 5F-5I relate to stock loans for Reg SHO pre-borrow stock. FIGS. 5A, 5B and 5F describe conventional systems. FIGS. 5C, 5D, 5E, 5G, 5H and 5I relate to ELMS 200.

FIG. 5A shows a conventional “manual” method for a short sale of GC or HTB stock. Trader 10 obtains a locate for a sell short order that she wishes to execute, and sends the sell short order and associated locate identifier to equity marketplace 5. Typically, trader 10 places a phone call or sends an email to prime broker 30 to obtain the locate.

FIG. 5B shows the above-described automated method for a short sale of GC or HTB stock. Trader 10 sends the sell short order to EMS 40. EMS 40 provides a locate and sends the sell short order and associated locate identifier to equity marketplace 5.

FIG. 5C shows ELMS 200 functioning in similar manner as EMS 40 in FIG. 5B. Trader 15 sends a sell short order to ELMS 200. ELMS 200 provides a locate and sends the sell short order and associated locate identifier to equity marketplace 6 (see FIG. 6A).

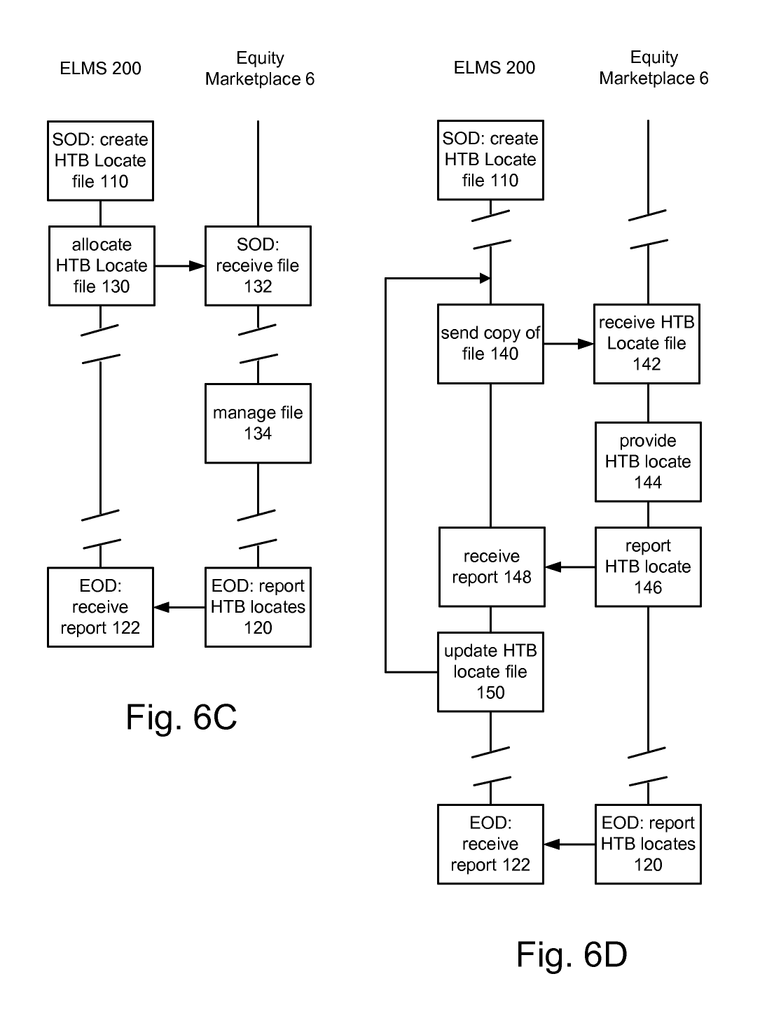

FIG. 5D shows trader 15 sending a sell short order for GC or HTB stock to marketplace 6, without a locate. Marketplace 6 obtains a locate in co-operation with ELMS 200 (see FIGS. 7A-7B). The discussion below presents three techniques for how marketplace 6 can obtain a locate in co-operation with ELMS 200: (a) asking ELMS 200 for a locate on an order by order basis (see FIG. 6B), (b) receiving from ELMS 200 an allocated HTB file and GC list so marketplace 6 determines on its own for each sell short order whether a locate is available (see FIG. 6C), and (c) interacting with a locate file centrally maintained by ELMS 200 (see FIG. 6D). Other techniques may be used as appropriate.

FIG. 5E shows trader 15 sending a locate request to ELMS 200, which replies with a locate. Trader 15 then sends a sell short order and associated locate to marketplace 5 that is not in direct communication with ELMS 200 (see FIG. 6A).

FIG. 5F is similar to FIG. 5A, except that trader 10 obtains a stock loan instead of a locate due to regulatory requirements.

FIG. 5G is similar to FIG. 5C, except that trader 15 sent a sell short order for Reg SHO pre-borrow stock to ELMS 200, which responded by obtaining a stock loan—not a stock locate—and then sending the sell short order and associated loan to equity marketplace 6 (see FIG. 6A).

FIG. 5H is similar to FIG. 5D, except that a loan is provided instead of a locate (see FIGS. 7A-7B).

FIG. 5I is similar to FIG. 5E, except that a loan is provided instead of a locate (see FIG. 6A).

ELMS 200 provides locates to trader 15, discussed with respect to FIG. 6A, and to equity marketplace 6 and derivatives marketplace 7, discussed with respect to FIG. 6B.

FIG. 6A shows processing when trader 15 requests a locate for a specified quantity of a particular stock from ELMS 200.

In this embodiment, ELMS 200 manages the inventory for locate requests on a transaction by transaction basis.

At step 100, trader 15 sends a request to ELMS 200.

A request for locate can be either explicit or implicit. An implicit request occurs when trader 15 sends a short sell order lacking a locate with instructions to forward to equity marketplace 6 after obtaining a locate. If trader 15 wishes to execute at equity marketplace 5 that is not in communication with ELMS 200, trader 15 must explicitly use ELMS 200 to obtain a locate, then send the sell short order and associated locate to equity marketplace 5.

When trader 15 is in the penalty box, at step 101, trader 15 explicitly requests a loan. For Reg SHO stock, trader 15 can request a loan or locate. When requesting a loan, trader 15 can also provide details of her short sell order and where to send to short sell order and the loan.

At step 101, trader 15 receives a response to her request from ELMS 200.

At step 102, ELMS 200 receives the locate or loan request.

At step 103, ELMS 200 determines if the request is for a loan or locate. If a loan, processing continues at step 104. If a locate, processing continues at step 108.

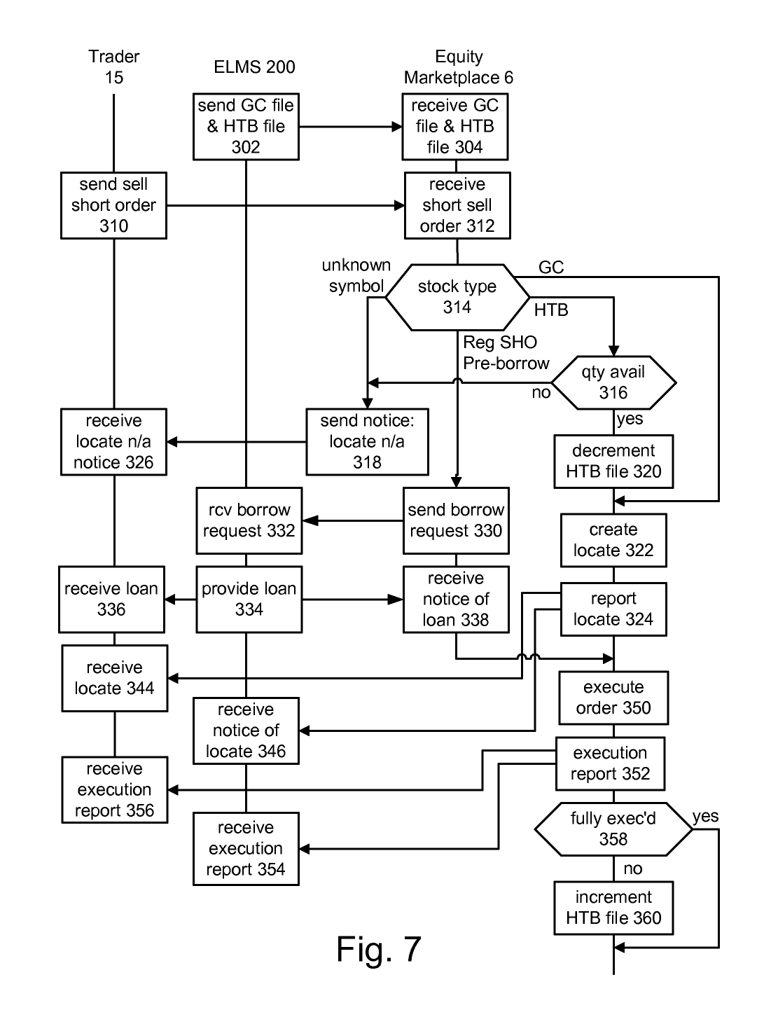

At step 104, ELMS 200 provides the loan, using a technique described in FIG. 8A or 8B, discussed below, or other suitable technique. See the discussion below of FIG. 7 step 334. If the loan cannot be obtained, ELMS 200 generates a loan unobtainable message (not shown) and sends the message to trader 15, and processing continues at step 101.

At step 105, ELMS 200 checks whether the loan is to be forwarded to marketplace 6. When trader 15 has specified the details of a sell short order and explicitly indicated marketplace 6, such as by setting a “forward” flag, then the loan is to be forwarded.

If the loan is to be forwarded, then at step 106, ELMS 200 sends the sell short order and loan to the indicated marketplace, such as marketplace 6, and processing continues at step 166. ELMS 200 also sends a confirmation of the forwarding (not shown) to trader 15.

If the loan is not to be forwarded, then processing continues at step 101.

At step 108, ELMS 200 invokes its locate module 715, shown in FIG. 3. Locate module 715 determines the type of the stock by first checking whether the symbol is in the GC Locate File; if so, processing continues at step 176. Second, locate module 715 checks whether the symbol is in the Reg SHO Pre-borrow file; if so, processing continues at step 104. Third, locate module 715 checks whether the symbol is in the HTB file; if so, processing continues at step 170. If ELMS 200 cannot find the symbol in its GC file, its Reg SHO file or its HTB file, then processing continues at step 172.

At step 170, locate module 715 checks whether there is sufficient quantity to provide the locate. If there is insufficient quantity, processing continues at step 172. If there is sufficient quantity to provide the requested locate, processing continues at step 174.

At step 172, locate module 715 generates a locate refusal message, sends the locate refusal to trader 15, and processing continues at step 101.

In some embodiments, if there is insufficient quantity to provide the requested locate, then locate module 715 provides a partial locate, that is, a locate for the amount available that is less than the amount requested, and processing continues at step 178. Locate module 715 generates a partial refusal, sends the partial refusal to trader 15, and processing continues at step 101.

At step 174, locate module 715 decrements the quantity in the HTB locate file by the requested quantity.

At step 176, locate module 715 provides the requested locate and processing resumes in other portions of ELMS 200.

At step 178, ELMS 200 checks whether the locate was obtained for a sell short order that is to be forwarded. If not, ELMS 200 reports the locate to trader 15 and processing continues at step 101. If forwarding is needed, then at step 180, ELMS 200 sends the sell short order and associated locate to equity marketplace 6, and sends a confirmation of the forwarding (not shown) to trader 15.

At step 166, equity marketplace 6 receives the sell short order and associated locate or loan, executes the order (not shown, similar to step 74 in FIG. 2A), and sends an execution report back to ELMS 200 (not shown, similar to step 76 in FIG. 2A). ELMS 200 receives the execution report and forwards it (not shown, similar to step 78 in FIG. 2A) to trader 15.

Equity marketplace 6 and derivatives marketplace 7 are treated similarly with respect to locate requests, and only marketplace 6 will be discussed below, for brevity.

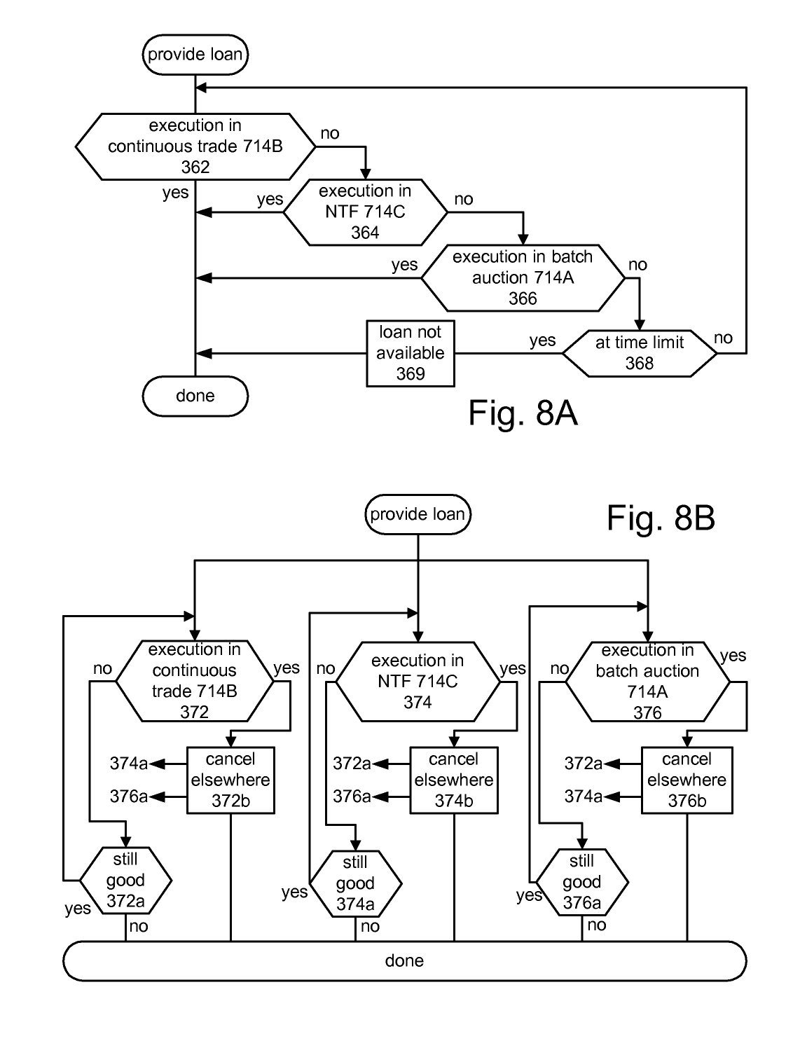

ELMS locate module 715 provides HTB locates to marketplace 6 according to different embodiments: per transaction locates, an allocated HTB locate file with GC list, and a centrally maintained HTB locate file with GC list. These are discussed with references to FIGS. 6B-6D, and then the overall interaction between ELMS 200 and marketplace 6 is discussed with references to FIGS. 7 and 9.

FIG. 6B shows provision of a locate from ELMS 200 to marketplace 6 according to a per transaction method.

At step 110, at the start of the trading day, ELMS 200 creates a daily HTB locate file according to the “historical calculated” method, the “actual” method or the “estimated” method, as discussed above.

During the trading day, at step 112, marketplace 6 sends a HTB locate request to ELMS 200. At step 114, ELMS 200 receives the request. At step 115, locate module 715 of ELMS 200 decrements the quantity requested from the HTB locate file created at step 110, and at step 116, provides the locate and sends the locate to marketplace 6. If there is insufficient quantity, at step 117, ELMS 200 notifies marketplace 6 that the locate request is refused due to insufficient quantity. At step 118, marketplace 6 receives either the granted locate or a refusal to grant the locate.

At the end of the trading day, at step 120, marketplace 6 prepares and sends a “net locates report” to ELMS 200 of the locates actually used and/or not used. It will be appreciated that if a locate is granted, but the associated short sale order is not executed, then the locate will not be used. At step 122, ELMS 200 receives the net locates report and updates its daily locate activity.

In some embodiments, marketplace 6 reports its used/not used locates to ELMS 200 more frequently, such as hourly or when a predetermined number of locates or shares has been used or not-used.

In embodiments where there is no contractual link between the locate and the delivery of shares on settlement day, ELMS 200 does not track the settlement needs prior to settlement, or at all.

FIG. 6C shows provision of a locate from ELMS 200 to marketplace 6 according to an allocated HTB locate file method. Steps 110, 120 and 122 are described with regard to FIG. 6B.

At step 130, during its start of day processing, ELMS 200 allocates the HTB locate file to the marketplaces that are configured to request locates therefrom, in this example, itself and marketplace 6. It will be appreciated that in other embodiments, there may be multiple remote marketplaces using ELMS 200 for locates. The allocation may be done according to any suitable method, such as a fixed percentage, e.g., 80% of the locate file to ELMS 200 and 20% to marketplace 6, or based on historical activity from all locate requestors, e.g., 90% of the locate file to ELMS 200 and 10% to marketplace 6 except that symbols XYZ, YZX and ZXY are allocated 40% to ELMS 200 and 60% to marketplace 6. At step 132, marketplace 6 receives its allocation of the HTB locate file along with a list of GC symbols.

At step 134, during the trading day, when a short-seller at marketplace 6 needs a HTB locate, marketplace 6 consults its allocation and determines whether or not it can provide a locate therefrom to the requesting short-seller. If so, marketplace 6, decrements the quantity for the appropriate symbol in its allocation of the HTB locate file. If not, marketplace 6 determines that it cannot provide a locate based on ELMS 200 stock supply. If the short-seller needs a GC locate, marketplace 6 simply provides it (not shown).

In embodiments having a pre-allocated HTB locate file, when marketplace 6 lacks quantity to satisfy a locate request, marketplace 6 can ask other entities having a pre-allocated HTB locate file whether they have quantity to satisfy the locate request. If so, in these embodiments, entities have a procedure for transferring HTB locate quantity between entities.

FIG. 6D shows provision of a locate from ELMS 200 to marketplace 6 according to a centrally maintained HTB locate file method, with ELMS 200 being the central maintainer of the HTB locate file. Steps 110, 120 and 122 are described with regard to FIG. 6B.

At step 140, ELMS 200 sends a copy of its entire HTB locate file to marketplace 6. At step 142, marketplace 6 receives the HTB locate file.

At step 144, marketplace 6 determines that there is sufficient quantity for a symbol to provide a locate, and marketplace 6 provides the locate to enable an order execution in its marketplace. At step 146, marketplace 6 reports the locate to ELMS 200. At step 148, ELMS 200 receives the locate report. At step 150, ELMS 200 decrements the available quantity in the HTB locate file, and processing returns to step 140, where the updated HTB locate file is sent to marketplace 6. It will be appreciated that the entire file need not be sent each time, rather, an update of quantity available for a particular symbol may be sent. If the symbol is a GC stock, then marketplace 6 simply provides the locate without reporting anything about the locate to ELMS 200.

The methods of FIGS. 6C and 6D generally enable faster order processing at marketplace 6 than the method of FIG. 6B.

FIG. 7 is a flowchart showing activity for a short sale on day T at marketplace 6 using locates from ELMS 200. Let it be assumed that the HTB locate file is created using the “historical calculated” method described above, and that the allocated HTB locate file method of FIG. 6C is used. In other embodiments, other variations are employed.

Steps 302, 304 occur during start of day processing.

At step 302, ELMS 200 sends its daily GC locate file and an allocation of its daily HTB locate file to marketplace 6. At step 304, marketplace 6 receives the GC locate and the HTB locate file. Let it be assumed that on a previous day, ELMS 200 has sent its Reg SHO Pre-borrow file to marketplace 6.

As used herein and in the claims, trader 15 represents both the end-user making buy and sell decisions (which may be a human or a computer program), and the clearing broker for the end-user. Generally, marketplace 6 accepts orders only from clearing members such as its clearing brokers, and not directly from end-users. It is common practice for clearing brokers to provide automated interfaces for order entry to their end-users, and as long as the end-users do not exceed thresholds determined by the clearing brokers, such as dollar amount of an order, then the clearing broker automated interface merely passes the end-user order through to marketplace 6. Thus, it is reasonable to aggregate the end-user and the clearing broker as trader 15.

During the trading day, at step 310, trader 15 sends a sell short order without a locate to marketplace 6. At step 312, marketplace 6 receives the sell short order.

At step 314, marketplace 6 determines the type of the stock in the sell short order by first checking whether the symbol is in the GC locate File received at step 304; if so, processing continues at step 340. Second, marketplace 6 checks whether the symbol is in the Reg SHO Pre-borrow file; if so, processing continues at step 330. Third, marketplace 6 checks whether the symbol is in the HTB locate file; if so, processing continues at step 316. If marketplace 6 cannot find the symbol in its GC file, its Reg SHO file or its HTB file, then processing continues at step 318.

At step 316, marketplace 6 checks whether there is sufficient quantity to provide the locate. If there is insufficient quantity, processing continues at step 318. If there is sufficient quantity to provide the requested locate, processing continues at step 320.

At step 318, marketplace 6 generates a locate refusal message, and sends the locate refusal to trader 15. At step 326, trader 15 receives the locate not available message, and processing is complete.

In some embodiments, if there is insufficient quantity to provide the requested locate, then marketplace 6 provides a partial locate, as generally discussed above.

At step 320, marketplace 6 decrements the quantity in its HTB locate file by the quantity in the sell short order.

At step 322, marketplace 6 provides a locate for the sell short order. At step 324, marketplace 6 reports the locate to ELMS 200 and trader 15, and processing for marketplace 6 continues at step 350. At step 344, trader 15 receives the notice of locate. At step 346, ELMS 200 receives the notice of locate. In some embodiments, reporting of the locate to ELMS 200 is omitted.

At step 330, marketplace 6 has determined that the stock must be pre-borrowed, that is, a locate cannot be provided due to regulatory reasons. Marketplace 6 sends a stock loan request to ELMS 200.

At step 332, ELMS 200 receives the borrow request, confirms that trader 15 is a member of ELMS 200, and, at step 334, tries to execute the borrow request by obtaining a loan. If trader 15 is not a member of ELMS 200, then the borrow request is refused due to an unknown borrower.

It will be recalled that ELMS 200 has three price discovery and execution facilities: batch auction 714A, continuous auction 714B and negotiated trade facility 714C. FIGS. 8A and 8B elucidate different methods of exposing the borrow request to these execution facilities; other methods, and variations of the methods, of exposing the borrow request to the execution facilities are also possible. That is, step 334 of FIG. 7 is implemented via FIG. 8A, FIG. 8B or other suitable method.

FIG. 8A depicts a method for sequentially exposing the borrow request to the execution facilities of ELMS 200.

At step 362, ELMS 200 determines whether a continuous auction is available. It will be recalled that a continuous auction is not available when a batch auction is occurring. When a continuous auction is available, i.e., when a batch auction is not in progress, ELMS 200 tries to execute the borrow request in the continuous auction, and if executed, processing is complete.

If the continuous auction is unavailable, or an execution is not provided via the continuous auction, ELMS 200 tries to execute the borrow request using its negotiated trade facility. The terms of the borrow request are determined by the short sell order from trader 15, which may include terms especially for the negotiated trade facility. Additionally, ELMS 200 may impose default constraints, such as the price for the borrow request being within a predetermined range relative to recent similarly executed stock loans. If a stock loan is accomplished via the negotiated trade facility, then processing is complete.

If an execution is not obtained in the continuous auction facility or the negotiated trade facility, then at step 366, ELMS 200 submits the borrow request to the next batch auction. It will be recalled that batch auctions occur at predetermined times of the day. If the borrow request is satisfied using the batch auction, then processing is complete.

If no execution of the borrow request occurs in any of its three loan execution facilities, at step 368, ELMS 200 determines whether a time limit for responding to the borrow request has been reached. If so, at step 369, ELMS 200 sends a loan unavailable notice to marketplace 6 and processing is complete.

If the time limit for responding to the borrow request has not been reached, then processing returns to step 362, to continue trying to provide a stock loan.

FIG. 8B depicts a method for contemporaneously (in parallel) exposing the borrow request to the execution facilities of ELMS 200.

At steps 372, 374, 376, which occur substantially simultaneously, ELMS 200 exposes the borrow request to each of its continuous trade process 714B, negotiated trade facility 714C and batch auction 714A.

If an execution is obtained in one of modules 714A, 714B, 714C, then at the appropriate one of steps 372b, 374b, 376b, a notice is sent to the other facilities to cancel the borrow request.

If an execution is not obtained within a predetermined time in one of modules 714A, 714B, 714C, then at steps 372a, 374a, 376a, which may occur substantially simultaneously, it is determined whether the time limit for responding to the borrow request has been reached. If the time limit has been reached, ELMS 200 sends a loan unavailable notice to marketplace 6 and processing is complete.

If the time limit for responding to the borrow request has not been reached, then processing returns to respective ones of steps 372, 374, 376, to continue trying to provide a stock loan.

Returning to FIG. 7 step 334, and assuming a stock loan has been obtained as just discussed, ELMS 200 sends a notice of the loan to trader 15 and marketplace 6. At step 336, trader 15 receives notice of the loan. At step 338, marketplace 6 receives notice that the requested loan has been provided, which converts the short sell order lacking a locate into an executable short sell order.

At step 350, marketplace 6 executes the short sell order, that is, matches the short sell order with a buy order. The execution may be for the full quantity of the sell short order or a partial quantity.

At step 352, marketplace 6 sends an execution report to trader 15 and to ELMS 200. At step 354, ELMS 200 receives the execution report. At step 356, trader 15 receives the execution report for its sell short order.

At step 358, marketplace 6 checks whether the full amount of the sell short order has been executed. If yes, processing is complete. If only a partial amount of the sell short order has been executed and the symbol is for a HTB stock, at step 360, marketplace 6 increments the quantity in its allocation of the HTB locate file by the unexecuted amount, and processing is complete.

In an alternate embodiment, at step 358, if only a partial amount of the sell short order has been executed, marketplace 6 returns to step 350 to execute the remainder of the sell short order.

FIG. 9 is a flowchart showing post-trade activity for the short sale.

On trade day T, at the end of the day, at step 380, marketplace 6 sends a net locates file to ELMS 200, corresponding to step 120 of FIGS. 6B-6D. At step 382, ELMS 200 receives the net locates file, corresponding to step 122 of FIGS. 6B-6D.

On day T+2, at the end of the day, at step 384, ELMS 200 retrieves from its storage records of the locates provided on day T, and for each such locate, sends a confirmation request to the recipient of the locate, e.g., trader 15. At step 386, trader 15 receives the locate confirmation request. Trader 15 determines whether it needs a loan corresponding to the locate, that is, whether the short sale is still on its books or has been extinguished by purchasing the stock, that is, covering the short. Many short sales are for less than three days; locates never mature into loans for these short sales. At step 388, trader 15 advises ELMS 200 whether or not it requires a loan.

At step 390, ELMS 200 receives the notice from trader 15 as to whether a loan is required. In one embodiment, if a loan is not required, then trader 15 is charged for the locate, while if a loan is required, then there is no charge for the locate. In other embodiments, the charge for the locate, if any, does not depend on whether the locate matures into a loan. After step 390 is completed for all locates provided on day T, ELMS 200 knows the loans it must actually provide on day T+3.

On day T+3, at the start of the day, at step 392, ELMS 200 provides the loans corresponding to the confirmed locates. The loans are provided using the loan execution facilities of ELMS 200, as described above in FIGS. 8A, 8B, or in some embodiments, in a start of day auction held for locates that have matured into loans. ELMS 200 sends a notice of the loan to trader 15 and sends the shares to broker 30 associated with trader 15. It will be understood that the shares are sent by appropriately debiting and crediting the shares balances at a depository corporation where ELMS 200 and broker 30 have accounts, avoiding the need to physically transfer paper shares.

At step 394, trader 15 receives the notice of the loan.

At step 396, broker 30 receives the shares from ELMS 200, corresponding to FIG. 3 step 94, receiving shares from an external third party.

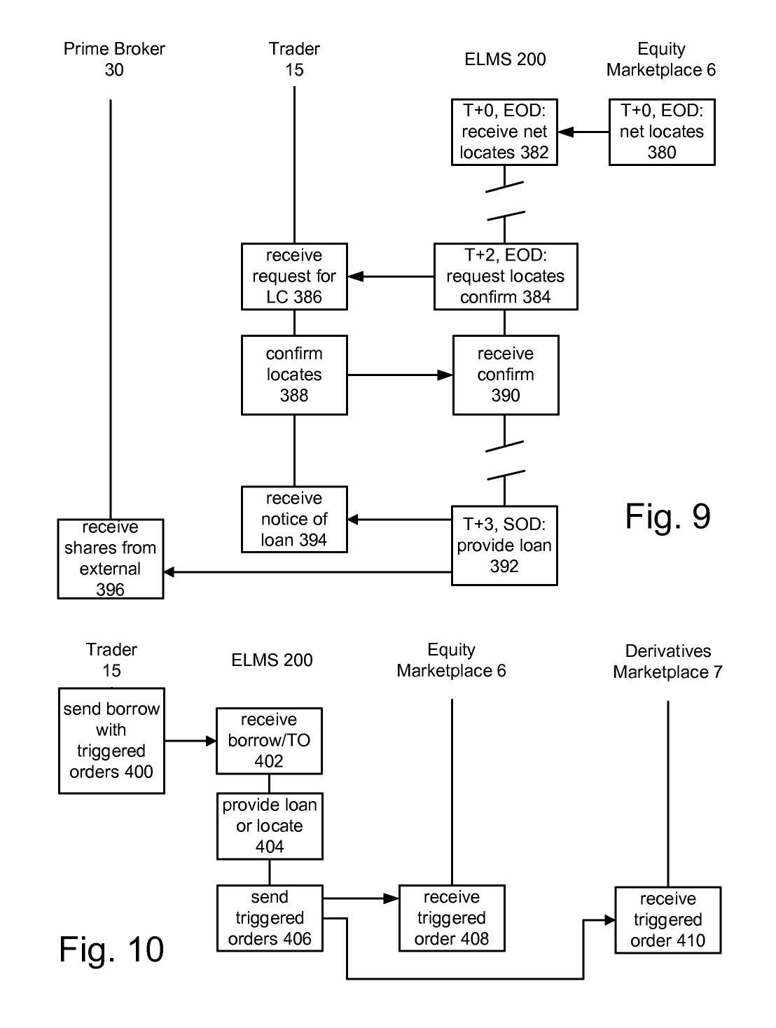

FIG. 10 is a flowchart showing processing for a stock loan request having associated orders to be triggered if the loan is obtained.

The profitability of an arbitrage trade involving an equity short sale and its derivative, such as an option or future, may depend on the financing cost of obtaining a loan for the equity. Accordingly, it is useful for trader 15 to be able to send a stock loan request to ELMS 200 accompanied by an order in equity marketplace 6 and/or derivative marketplace 7 that is to be triggered if the stock loan is obtained within the parameters of the stock loan request.

At step 400, trader 14 sends a borrow request with at least one order for another marketplace that is to be triggered if the borrow request is filled, referred to as a borrow/TO (triggered order). Table 1 shows an example of a borrow/TO having two triggered orders. Note that for options, an order is expressed in the form
SSS.mmmyyyy.ppp[.pp]XXXX

where SSS indicates the stock symbol
mmm indicates the month of the option series
yyyy indicates the year of the option series
ppp[.pp] indicates the price, with an optional decimal portion)
XXXX indicates the order type, i.e., PUT or CALL

TABLE 1

| Borrow Order | Triggered Order-1 | Triggered Order-2 | Triggered Order-3 |
|---|---|---|---|
| traderID = 015 | traderID = 015 | traderID = 015 | traderID = 015 |
| symbol = XYZ | destin = market 6 | destin = market 7 | destin = market 7 |
| quantity = 1000 | symbol = XYZ | symbol = | symbol = |
| action = borrow | action = sell short | XYZ.Jul2010.50PUT | XYZ.Jul2010.50CALL |
| rebate rate = −0.03 | quantity = 1000 | action = sell | action = buy |
| | price = $50 | quantity = 1000 | quantity = 1000 |
| | | strike = $50 | strike = $50 |

At step 402, ELMS 200 receives the borrow/TO from trader 15.

At step 404, ELMS 200 provides a loan or locate, as generally described above with regard to FIG. 6A.

At step 406, ELMS 200 sends Triggered Order-1 to equity marketplace 6, and sends Triggered Order-2 and Triggered Order-3 to derivative marketplace 7.

At step 408, marketplace 6 receives Triggered Order-1 and executes according to its local rules, then reports the execution in conventional manner with a copy to ELMS 200.

At step 410, marketplace 7 receives Triggered Order-2 and Triggered Order-3 and executes according to its local rules, then reports the executions in conventional manner with a copy to ELMS 200.

Although illustrative embodiments of the present invention, and various modifications thereof, have been described in detail herein with reference to the accompanying drawings, it is to be understood that the invention is not limited to these precise embodiments and the described modifications, and that various changes and further modifications may be effected therein by one skilled in the art without departing from the scope or spirit of the invention as defined in the appended claims.

What is claimed is:

1. A method of providing a locate for a stock loan for a hard to borrow stock, comprising:
receiving a request for the locate, the request being for a requested quantity, from an entity holding a sell short order for a hard to borrow stock,
automatically determining, by a program executing on a computer, an available quantity in a file, whether there is sufficient available quantity to provide the requested quantity,
when there is sufficient available quantity, automatically decrementing, by the program, the available quantity by the requested quantity, and
replying to the entity with a locate for the requested quantity.

2. The method of claim 1, wherein the file was created in a start of day process using a historical calculated method wherein the available quantity is estimated based on borrowing activity during a plurality of preceding days.

3. The method of claim 1, wherein the file was created in a start of day process using an actual method wherein the available quantity results from summing amounts of stock, owned by other users of the program executing on the computer, that are available for locates.

4. The method of claim 1, wherein the file was created in a start of day process using an estimated method wherein the available quantity results from summing estimates, provided by other users of the program executing on the computer, that are available for locates.

5. The method of claim 1, wherein the entity is a marketplace, and further comprising receiving a net locates report from the marketplace.

6. The method of claim 1, wherein the request is associated with a triggered order, and further comprising sending the triggered order to a marketplace, the marketplace being different than the entity.

7. A method of providing a locate for a stock loan for a hard to borrow stock, comprising:
in a process executing on a computer, creating a hard to borrow file,
sending the hard to borrow file to a marketplace, and
receiving a locate usage report from the marketplace.

8. The method of claim 7, wherein the creating of the hard to borrow file includes an available quantity estimated based on borrowing activity during a plurality of preceding days.

9. The method of claim 7, wherein the creating of the hard to borrow file includes an available quantity resulting from summing amounts of stock, owned by members of a stock loan system, that are available for locates.

10. The method of claim 7, wherein the creating of the hard to borrow file includes an available quantity resulting from summing estimates, provided by members of a stock loan system, that are available for locates.

11. The method of claim 7, further comprising allocating, in the start of day process, a portion of the hard to borrow file to the marketplace, and wherein the sending sends only the allocated portion to the marketplace.

12. The method of claim 7, further comprising
updating, by a second process executing on the computer, the hard to borrow file based on the locate usage report, and
sending an update representing the updated hard to borrow file to the marketplace.

13. A method of providing a stock loan for a sell short order, comprising:
receiving, at a computer, the sell short order from a trader,
automatically, at the computer, obtaining a stock loan corresponding to the sell short order, and
sending the sell short order and notice of the stock loan from the computer to a first marketplace for execution of the sell short order.

14. The method of claim 13, wherein the stock loan is obtained by serially exposing a request for loan to at least two processes selected from a continuous trade process, a batch auction process and a negotiated trade facility process.

15. The method of claim 13, wherein the stock loan is obtained by exposing, in parallel, a request for loan to at least two processes selected from a continuous trade process, a batch auction process and a negotiated trade facility process.

16. The method of claim 13, wherein the sell short order is associated with a triggered order, and further comprising sending the triggered order to a second marketplace for execution, the second marketplace being different than the first marketplace.

17. A method of providing a stock loan for a sell short order, comprising:
receiving, at a computer, a request for the stock loan from a marketplace,
automatically, at the computer, obtaining a stock loan corresponding to the sell short order, and
sending a notice to the marketplace that a stock loan was obtained.

18. The method of claim 17, wherein the stock loan is obtained by serially exposing a request for loan to at least two processes selected from a continuous trade process, a batch auction process and a negotiated trade facility process.

19. The method of claim 17, wherein the stock loan is obtained by exposing, in parallel, a request for loan to at least two processes selected from a continuous trade process, a batch auction process and a negotiated trade facility process.

20. A method for executing a sell short order, comprising:
receiving, at a computer operated by a marketplace, the sell short order associated with a stock symbol,
determining, at the computer, whether the stock symbol is in a GC file maintained at the computer or a HTB file maintained at the computer,
when the stock symbol is in the GC file or a HTB file, creating, at the computer, a locate for the sell short order, and
executing, at the computer, the sell short order.

21. A method for executing a sell short order, comprising:
receiving, at a computer operated by a marketplace, the sell short order associated with a stock symbol,
determining, at the computer, whether the stock symbol is in a pre-borrow file maintained at the computer,
when the stock symbol is in the pre-borrow file, sending a request for a stock loan to a stock lending system,
receiving, at the computer, a notice from the stock lending system that the loan was granted, and
executing, at the computer, the sell short order.
